(19) United States
(12) Patent Application Publication
(10) Pub. No.: US 2025/0380122 A1
(43) Pub. Date: Dec. 11, 2025

(54) Emergency Preparedness System and Method

(71) Applicant: Joe Harb, Bellevue, WA (US)

(72) Inventor: Joe Harb, Bellevue, WA (US)

(21) Appl. No.: 19/228,768

(22) Filed: Jun. 5, 2025

Related U.S. Application Data
(60) Provisional application No. 63/656,406, filed on Jun. 5, 2024.

(51) Int. Cl. H04W 4/90; H04W 4/029

(52) U.S. Cl. CPC H04W 4/90; H04W 4/029

(57) ABSTRACT

An emergency preparedness system and method includes a communication unit to communicate personalized instructions to a user, based on type of emergency, location of the user relative to the emergency, user role and user language; an application executing on at least one user device associated with the user to receive the personalized instructions; an interactive broadcast platform to provide up-to-date information pertaining to the emergency; an off-network communication module to enable communication even in the event of a failure of cellular, internet, or other network infrastructure; and a simulation engine for training users in emergency response preparedness. The modular emergency preparedness system and method is designed to equip communities with the necessary means to effectively deal with and respond to a vast range of emergencies, from natural disasters like hurricanes, earthquakes, and floods, to human-made crises like terrorist acts, fires, chemical spills, or even unforeseen socio-economic disruptions.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates to systems and methods for emergency preparedness, communication, and response. More specifically, it concerns a modular, multi-platform ecosystem designed to support emergency readiness and response through real-time digital interactions, scenario-based training, and resilient offline communication protocols.

### RELATED ART

Effective and timely communication during disasters is crucial for minimizing casualties, preventing injuries, and ensuring coordinated efforts among various response teams. However, current disaster response systems face significant challenges, especially during natural disasters, terrorist attacks, pandemics, and other emergencies where access to timely information and community coordination is vital. Traditional broadcasting systems, while capable of delivering one-way alerts, lack interactivity and often fail during network disruptions. Similarly, mobile applications, though beneficial for preparedness and response, are heavily reliant on internet or cellular connectivity, making them vulnerable during infrastructure failures. The absence of real-time data feedback mechanisms further limits the ability of users to report incidents or receive timely updates.

Additional limitations include fragmented and disjointed communication channels that lead to confusion and inefficiency, as well as delayed alert dissemination that hampers swift response efforts. Generic, non-specific instructions often fail to address the unique needs of individuals in diverse situations, while language barriers in multilingual communities leave non-native speakers at heightened risk. Further, ineffective resource management results in poor deployment and coordination of critical supplies and personnel. Collectively, these issues highlight the urgent need for more resilient, inclusive, and real-time communication solutions in disaster response systems.

### SUMMARY OF THE INVENTION

In view of the foregoing disadvantages inherent in the known emergency communication art, the present disclosure provides a novel emergency preparedness system and method. The general purpose of the present disclosure, which will be described subsequently in greater detail, is to provide an integrated, interactive emergency preparedness and response system that functions both online and offline, includes community-driven feedback loops, and provides scenario-based training and secure communications, even when conventional networks are down.

A modular emergency preparedness system is disclosed herein. The modular emergency preparedness system may include at least one server, at least one processor, an application executing on at least one user device associated with a user, a communication unit, an off-network communication module and an interactive broadcast platform. The at least one processor may be configured to determine an emergency has occurred and identify a type and a location of the emergency, the application may be configured to determine a location of the user and the communication unit may be configured to send personalized instructions to the user device, over a communication network, based at least in part on one or more of the type of the emergency, the location of the user relative to the location of the emergency, a role of the user and a language preference of the user.

In the event of a failure of the communication network, the off-network communication module may be configured to receive encoded data embedded in radio signals that are distributed by a radio broadcast source, and further configured to decode the data for at least one of visual or audible presentation of the decoded data to the user on the at least one user device.

The interactive broadcast platform may be configured to maintain up-to-date information pertaining to the emergency, based on real-time data, for display to the user on the at least one user device and further configured to receive user submitted data from a plurality of users and facilitate two-way communication between the plurality of users.

According to another embodiment, a method for emergency event communication is also disclosed herein. The method for emergency event communication may include determining, by at least one processor communicatively coupled with at least one server, that an emergency has occurred; identifying, by the at least one processor, a type of the emergency; identifying, by the at least one processor, a location of the emergency; determining, by an application executing on at least one user device associated with a user, a location of the user; sending, by a communication unit communicatively coupled with the at least one server, personalized instructions to the at least one user device over a communication network, based at least in part on one or more of the type of the emergency, the location of the user relative to the location of the emergency, a role of the user and a language preference of the user; and in the event of a failure of the communication network, receiving, by an off-network communication module within the application, encoded data embedded in radio signals distributed by a radio broadcast source; decoding, by the off-network communication module, the data; and at least one of visually and audibly presenting, by the off-network communication module, the decoded data to the user on the at least one user device.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a modular emergency preparedness system and method, constructed and operative according to the teachings of the present disclosure.

FIG. 1 is a schematic diagram of an emergency preparedness system, according to an embodiment of the disclosure.

FIG. 2 is a schematic diagram of the emergency preparedness system, according to another embodiment of the disclosure.

FIG. 3 is a schematic diagram of an exemplary user device (a laptop computer) for use with the emergency preparedness system, according to an embodiment of the present disclosure.

FIG. 4 is a schematic diagram of another exemplary user device (a smartphone) for use with the emergency preparedness system, according to an embodiment of the present disclosure.

FIG. 5 is a schematic diagram of another exemplary user device (a car stereo system) for use with the emergency preparedness system, according to an embodiment of the present disclosure.

FIG. 6 is a flow diagram illustrating a method for emergency preparedness, according to an embodiment of the present disclosure.

FIG. 7 is another flow diagram illustrating the method for emergency preparedness, according to an embodiment of the present disclosure.

FIG. 8 is another flow diagram illustrating the method for emergency preparedness, according to an embodiment of the present disclosure.

FIG. 9 is another flow diagram illustrating the method for emergency preparedness, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to emergency event communication and more particularly to a modular emergency preparedness system and method as used to improve emergency readiness and response through real-time digital interactions, scenario-based training, and resilient offline communication protocols.

Generally, the modular emergency preparedness system and method provides a comprehensive emergency management system, or ‘Coordinated Response and Integrated Safety and Information System’ (CRISIS), comprising a digital platform/training engine for community training and simulations, allowing users to simulate emergency response actions; a real-time interactive broadcast system (‘EPTV’) that enables real-time, two-way communication with affected users; a secure command interface/emergency dashboard for institutions and emergency personnel for command, control, and decision-making; and an offline or off-network communication system operating over a protocol that transmits alerts and instructions using inaudible radio signal encoding (e.g., ultrasonic tones embedded in FM/AM broadcasts).

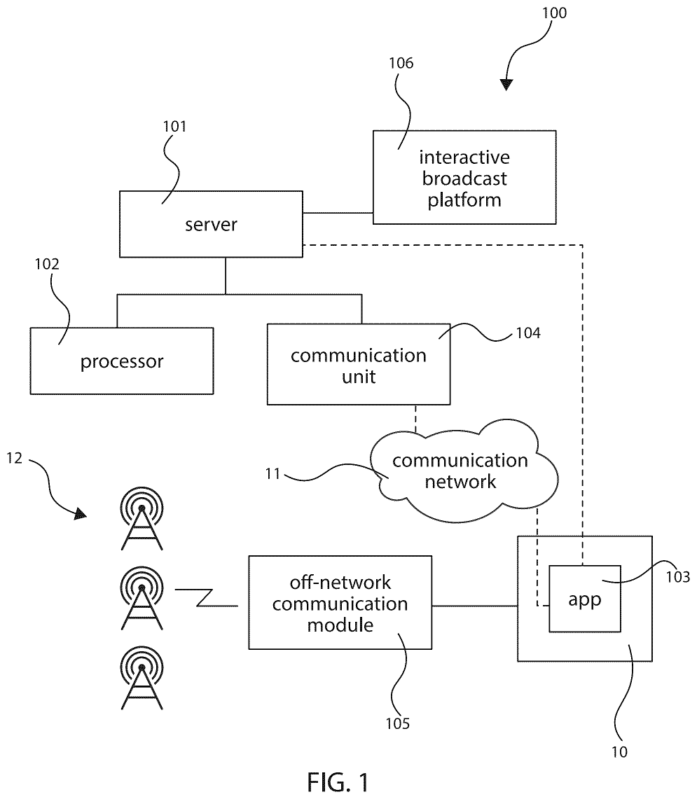

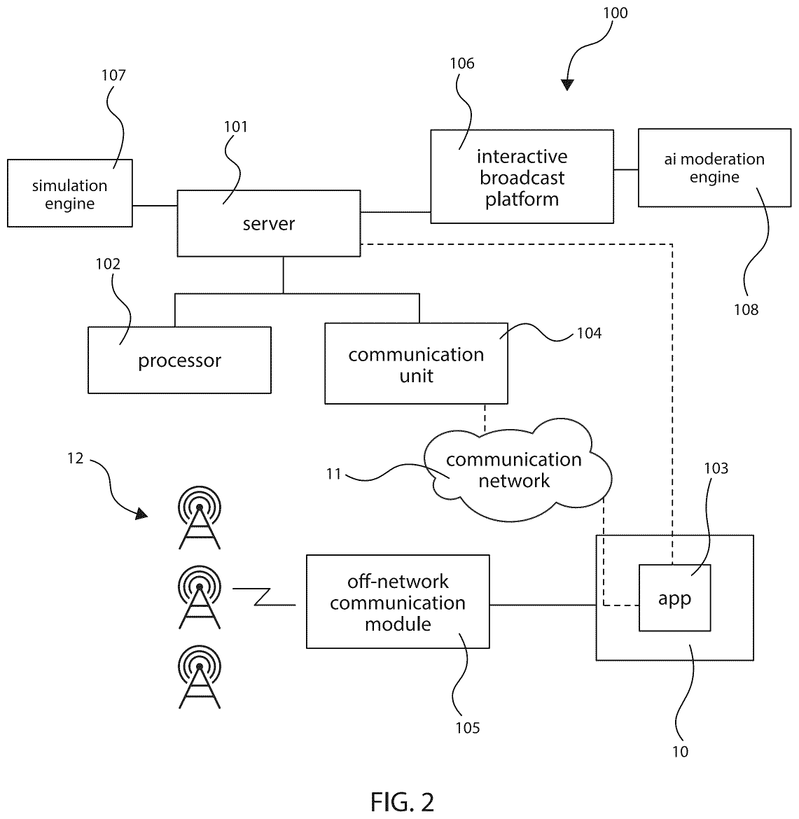

Referring now more specifically to the drawings by numerals of reference, there is shown in FIGS. 1-9, various views of the modular emergency preparedness system and method. Referring first to FIGS. 1-2, which illustrates a schematic diagram of a modular emergency preparedness system 100, according to one or more embodiments of the present disclosure. As shown in FIG. 1, in some embodiments, the modular emergency preparedness system 100 may include at least one server 101, at least one processor 102, an application 103 executing on at least one user device 10 associated with a user, a communication unit 104, an off-network communication module 105 and an interactive broadcast platform 106. In some embodiments, as demonstrated in FIG. 2, the modular emergency preparedness system 100 may include the at least one server 101, the at least one processor 102, the application 103 executing on at least one user device 10 associated with a user, the communication unit 104, the off-network communication module 105, the interactive broadcast platform 106, an artificial intelligence moderation engine 108, and a simulation engine 107. Further, the modular emergency preparedness system 100 may integrate with, or otherwise utilize, Artificial Intelligence (AI) for providing real-time, intelligent discussions to enhance decision-making and situational awareness.

The modular emergency preparedness system 100 is also API-compatible with local government systems, utility providers and international aid networks to aid in communication flow between citizens, responders, and institutions. Preferably, the modular emergency preparedness system 100 is a system of interconnected modules. The at least one server 101 may comprise a central server that hosts, or is at least communicatively coupled with, each element of the modular emergency preparedness system 100. The server 101 may utilize network protocols to enable communication between the elements directly or via a central processor. In some embodiments, the server 101 may include a plurality of dedicated servers, or any combination of central and distributed servers. Preferably, the modular emergency preparedness system 100 can be deployed on cloud, hybrid, or local servers with government-grade encryption and compliance.

The at least one processor 102, which may be integral to the at least one server 101 or communicatively coupled therewith, may be configured to determine if an emergency has occurred and identify a type and a location of the emergency. For example, types of emergencies determined by the at least one processor 102 may include (but are not limited to) earthquake, chemical spill, active shooter, tsunami, etc. The communication unit 104 may then be configured to send personalized instructions to the user device 10, over a communication network 11 (e.g., cellular network, the Internet, etc.), based on the type of the emergency, a location of the user relative to the location of the emergency, a role of the user, and/or a language preference of the user. The personalized instructions can be audible, visual, or a combination thereof. In some embodiments, Artificial Intelligence may be utilized to aid in the generation of the personalized instructions.

In terms of the type of the emergency, once the type has been determined, the communication unit 104 is able to send instructions that are specific to the type of emergency. For example, in an active shooter emergency the instructions may be to shelter in place, in a tornado emergency the instructions may be to evacuate, etc.

In terms of the location of the user relative to the location of emergency, the application 103 executing on the at least one user device 10 (e.g., a smartphone, desktop computer, tablet, car stereo system, etc.) may be configured to determine the location of the user via onboard systems such as a location module, processor, or similar components and is communicably coupled to the at least one processor 102 and the communication unit 104 such that the communication unit 104 is able to send the personalized instructions to users located in a predetermined area relative to the location of the emergency, ensuring that communication is directed to pertinent users, institutions and officials.

In terms of the role of the user, users of the modular emergency preparedness system 100 include emergency personnel, institutions, private citizens, etc., and as such, once the role of the user is determined (e.g., via profile information, which will be discussed in greater detail below), the communication unit 104 may send instructions specific to the role of the user. For example, a fire fighter would need different instructions than a private citizen.

In terms of the language preference of the user, a current problem faced in prior art systems is the lack of multilingual support, which leaves non-native speakers at risk. As such, once the language preference of the user is determined (e.g., via profile information, language settings in the at least one user device 10, etc.), the communication unit 104 may send instructions in, or including, the language preference of the user. In some embodiments, this may be aided by the utilization of Artificial Intelligence.

In some embodiments, the off-network communication module 105 may be integral to the application 103 executing on the at least one user device 10 of the user. In the event of a failure of the communication network 11, such as cell network failure, Internet failure, power outages, etc., an off-network communication protocol can be triggered. The off-network communication module 105 may thus be configured to receive encoded data embedded in radio signals that are distributed by a radio broadcast source 12 (e.g., radio stations), and decode the data for visual and/or audible presentation of the decoded data to the user on the at least one user device 10 (e.g., via a display or speaker of the at least one user device 10). The encoded data embedded in radio signals may include inaudible audio frequencies broadcast over standard radio waves (e.g., in the 18-20 kHz range) encoded with location-based instructions or safety data. Further, the off-network communication module 105 may be bi-directionally integrated with national or local broadcasting systems, allowing official institutions to push updates via partnering radio stations.

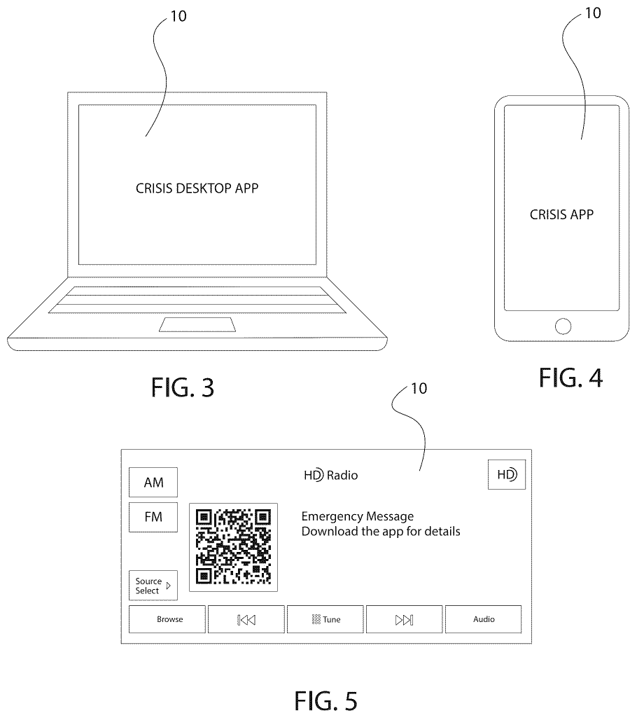

Referring now also to FIGS. 3-5, which are schematic diagrams showing example user devices contemplated for use with the modular emergency preparedness system 100. It should however be appreciated that the devices shown here are provided as examples only and do not limit the scope of the present invention. The at least one user device 10 may be any device able to receive communication. For example, a smartphone, a desktop computer, a tablet computer, a car stereo system, etc. Further, the at least one user device 10 may receive the inaudible audio frequencies via a microphone on or connected with the at least one user device 10. As shown here, the at least one user device 10 may include a plurality of devices each configured to receive instructions/information pertaining to the emergency via communication with the application 103 and/or the radio signals. For example, as shown here, the plurality of devices may include (but are not limited to) a computer (FIG. 3), a smartphone (FIG. 4) and a car stereo system (FIG. 5).

Where the at least one user device 10 includes a smartphone, at least a portion of the decoded data is presented as emergency instructions on a display and/or a speaker of the smartphone, via the application 103. For example, the emergency instructions may be presented as a push notification, as an audible alert, etc. Again, the emergency instructions may be personalized, based at least in part on one or more of the type of the emergency, the location of the user relative to the location of the emergency, the role of the user and the language preference of the user.

In some embodiments, where the at least one user device 10 includes a car stereo system, which may or may not include the application 103, at least a portion of the decoded data may be presented as a QR code on the car stereo system. As shown in FIG. 5, alongside the QR code may be a prompt message, prompting the user to download the application 103 onto another of the plurality of devices (e.g., a smartphone). Other portions of the decoded data may include personalized messages, again based at least in part on one or more of the type of the emergency, the location of the user relative to the location of the emergency, the role of the user and the language preference of the user.

The interactive broadcast platform 106 may be configured to maintain up-to-date information pertaining to the emergency, based on real-time data, for display to the user on the at least one user device 10. In some embodiments, the interactive broadcast platform 106 may be hosted on the at least one server 101 and accessible via the at least one user device 10, for example, via the application 103 or a website. The interactive broadcast platform 106 may provide role related access thereto, customizing what is seen by the user based on their role. In this embodiment, the at least one server 101 may store user profile information, storing data related to language preference, role, location, and other user data. For example, users with emergency personnel roles, institutions, etc. may have access to an emergency service dashboard (not shown). The emergency service dashboard may be used for command, control and decision making, to start polls and may also provide live user reports and broadcast capabilities.

The interactive broadcast platform 106 can be integrated with local or national TV stations, providing up-to-date, live coverage of the emergency. Further, the interactive broadcast platform 106 may be configured to receive user submitted data from a plurality of users and facilitate two-way communication between the plurality of users. In particular, the interactive broadcast platform 106 preferably provides an interactive platform where communities affected by the emergency can engage, share firsthand accounts, contribute to data collection and in some cases even steer the narrative of the coverage. For example, the user submitted data can include live updates, images, comments, videos, live streams, targeted questions, polls or instructions (e.g., from officials), etc. To safeguard data submitted on the interactive broadcast platform 106, the artificial intelligence moderation engine 108 may be communicatively coupled to the at least one server 101 and configured to filter the user submitted data for accuracy and relevance.

The interactive broadcast platform 106 thus allows for seamless sharing of resources, expert advice and real-time emergency management strategies among communities, emergency response teams, and the broader public. The interactive broadcast platform 106 can include live streaming, multiple simultaneous channels, on-demand video libraries, multiple languages, live polls, live interactions, video crowd sourcing during events, etc. Any data may be saved on the at least one server 101. Further, the interactive broadcast platform 106 may serve as a source of education and preparation in quieter times. For example, the interactive broadcast platform 106 can host interactive sessions on disaster preparedness, conduct virtual drills, and provide a platform for knowledge exchange and capacity-building initiatives, ultimately ensuring communities are prepared when crisis strikes.

Further, as discussed above, the modular emergency preparedness system 100 may integrate with, or otherwise utilize, Artificial Intelligence (AI) for providing real-time, intelligent discussions to enhance decision-making and situational awareness. As such, AI may be utilized to aid in communications throughout the interactive broadcast platform 106.

As shown in FIG. 2, the modular emergency preparedness system 100 may comprise a simulation engine 107. The simulation engine 107 again may be hosted on the at least one server 101 or at least communicatively coupled thereto. The simulation engine 107 may be configured to simulate a plurality of emergency events, track user decisions during simulation of each of the plurality of emergency events, generate a resilience score based at least in part on the user decisions and store user history and performance data on the at least one server 101. In particular, the simulation engine 107 may offer modular, gamified simulations for different emergency types (earthquake, chemical spill, active shooter, etc.), allowing users to simulate emergency response actions and increase preparedness therefor.

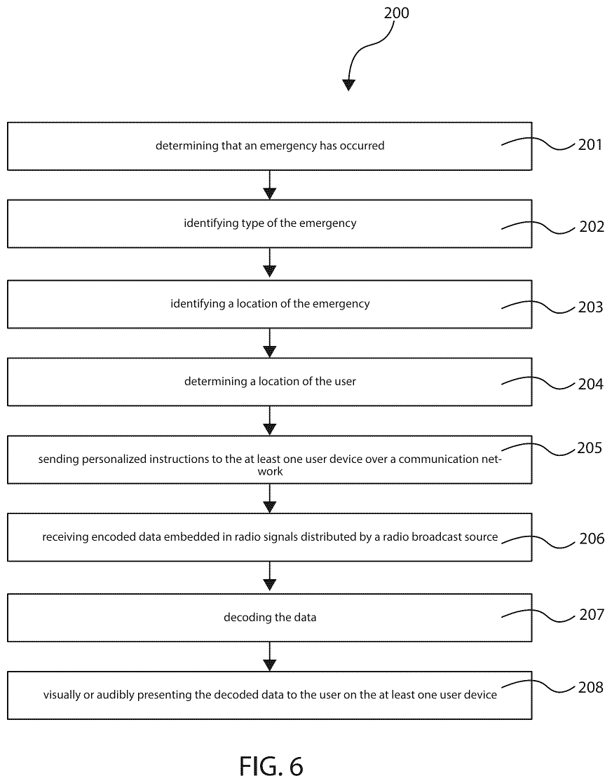

Referring now also to FIGS. 6-9, which are flow diagrams demonstrating a method for emergency preparedness 200, according to one or more embodiments of the present disclosure. The method for emergency preparedness 200 may be performed using some or all of the elements of the modular emergency preparedness system 100 as discussed above and illustrated in FIGS. 1-2.

As shown in FIG. 6, the method for emergency preparedness 200 may include the steps of: step one 201, determining, by at least one processor 102 communicatively coupled with at least one server 101, that an emergency has occurred; step two 202, identifying, by the at least one processor 102, a type of the emergency; step three 203, identifying, by the at least one processor 102, a location of the emergency; step four 204, determining, by an application 103 executing on at least one user device 10 associated with a user, a location of the user; step five 205, sending, by a communication unit 104 communicatively coupled with the at least one server 101, personalized instructions to the at least one user device 10 over a communication network 11, based at least in part on one or more of the type of the emergency, the location of the user relative to the location of the emergency, a role of the user and a language preference of the user; step six 206, in the event of a failure of the communication network 11, receiving, by an off-network communication module 105 within the application 103, encoded data embedded in radio signals distributed by a radio broadcast source 12; step seven 207, decoding, by the off-network communication module 105, the data; and step eight 208, at least one of visually and audibly presenting, by the off-network communication module 105, the decoded data to the user on the at least one user device 10.

As discussed above, in the event of a failure of the communication network 11, an off-network communication protocol can be triggered. The off-network communication module 105 may thus be configured to receive encoded data embedded in radio signals that are distributed by a radio broadcast source 12 and decode the data for visual and/or audible presentation of the decoded data to the user on the at least one user device 10 (e.g., via a display or speaker of the at least one user device 10). The encoded data embedded in radio signals may include inaudible audio frequencies broadcast over standard radio waves (e.g., in the 18-20 kHz range) encoded with location-based instructions or safety data. As discussed above, the radio signals may be received by devices such as (but not limited to) smartphones, computers and car stereo systems.

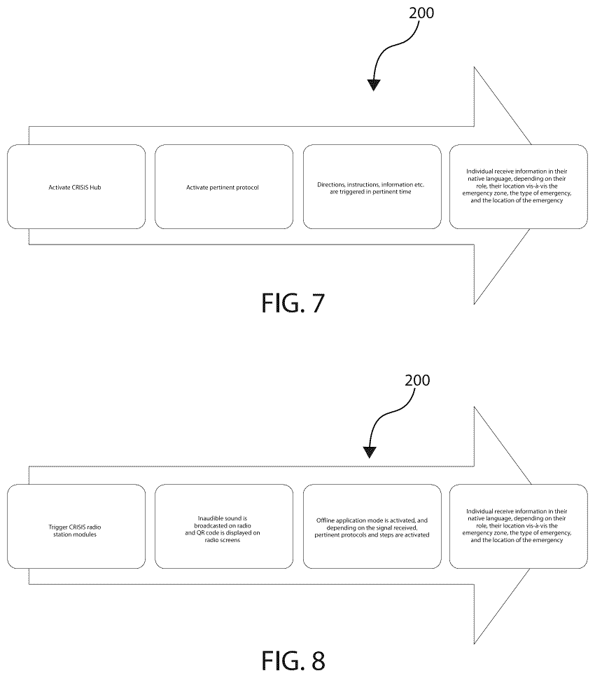

FIGS. 7-8 show example steps taken depending on whether there has been a communication network fail. FIG. 7 shows the steps of activating the emergency preparedness system 100 (CRISIS); activating pertinent protocol; triggering directions, instructions, information, etc.; and receiving (by the user) information in their native language, dependent on their role, their location to the emergency, the type of emergency and the location of the emergency. FIG. 8 shows steps taken in the event of network failure: triggering CRISIS radio station modules; broadcasting inaudible sound and displaying QR code on radio screens; activating offline mode on the application and depending on the signal received, pertinent protocols and steps activated; and receiving (by the user) information in their native language, dependent on their role and their location to the emergency.

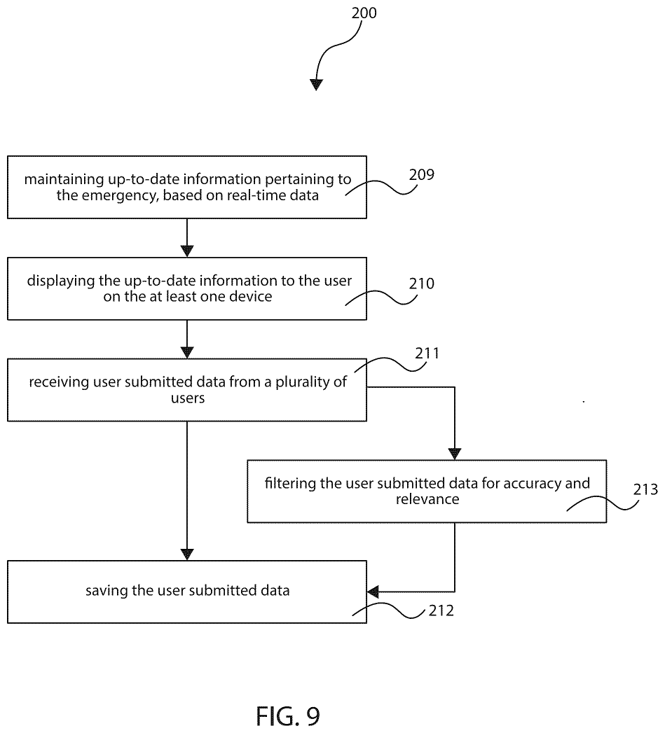

As shown in FIG. 9, a step nine 209 of the method for emergency preparedness 200 may include maintaining, by an interactive broadcast platform 106 hosted on the at least one server 101 accessible via the at least one user device 10, up-to-date information pertaining to the emergency, based on real-time data; step ten 210, upon request by the at least one user device 10, displaying the up-to-date information pertaining to the emergency to the user on the at least one user device 10; step eleven 211, receiving, by the interactive broadcast platform 106, user submitted data from a plurality of users; and step twelve 212, saving the user submitted data on the at least one server 101 for display on the at least one user device 10. Further, step thirteen 213 may include filtering, by an artificial intelligence moderation engine 108 communicatively coupled to the at least one server 101, the user submitted data for accuracy and relevance prior to the step of saving the user submitted data on the at least one server 101 for display on the at least one user device 10.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A modular emergency preparedness system comprising:
at least one server;
at least one processor communicatively coupled with the at least one server;
the at least one processor configured to determine that an emergency has occurred and identify a type and a location of the emergency;
an application executing on at least one user device associated with a user, the application configured to determine a location of the user;
a communication unit communicatively coupled with the at least one server, the communication unit configured to send personalized instructions to the user device over a communication network, based at least in part on one or more of the type of the emergency, the location of the user relative to the location of the emergency, a role of the user and a language preference of the user;
an off-network communication module within the application configured to:
receive encoded data embedded in radio signals that are distributed by a radio broadcast source in the event of a failure of the communication network; further configured to:
decode the data for at least one of visual and audible presentation of the decoded data to the user on the at least one user device; and
an interactive broadcast platform communicatively coupled with the at least one server, the interactive broadcast platform configured to maintain up-to-date information pertaining to the emergency, based on real-time data, for display to the user on the at least one user device, the interactive broadcast platform further configured to receive user submitted data from a plurality of users and facilitate two-way communication between the plurality of users.

2. The modular emergency preparedness system of claim 1, further comprising:
a simulation engine communicatively coupled with the at least one server, the simulation engine configured to simulate a plurality of emergency events.

3. The modular emergency preparedness system of claim 2, wherein the simulation engine is configured to track user decisions during simulation of each of the plurality of emergency events and generate a resilience score based at least in part on the user decisions.

4. The modular emergency preparedness system of claim 3, wherein the simulation engine is configured to store user history and performance data on the at least one server.

5. The modular emergency preparedness system of claim 1, wherein the encoded data embedded in radio signals includes inaudible audio frequencies broadcast over standard radio waves.

6. The modular emergency preparedness system of claim 5, wherein the at least one user device includes a microphone, and wherein the application receives the inaudible audio frequencies via the microphone.

7. The modular emergency preparedness system of claim 5, wherein the at least one user device includes a smartphone, and wherein at least a portion of the decoded data is presented as emergency instructions on at least one of a display and a speaker of the smartphone.

8. The modular emergency preparedness system of claim 7, wherein the emergency instructions are personalized, based at least in part on one or more of the type of the emergency, the location of the user relative to the location of the emergency, the role of the user and the language preference of the user.

9. The modular emergency preparedness system of claim 1, wherein the at least one server is at least one of cloud-based, hybrid and local.

10. The modular emergency preparedness system of claim 1, further comprising an artificial intelligence moderation engine communicatively coupled to the at least one server, and wherein the user submitted data is filtered by the artificial intelligence moderation engine for accuracy and relevance.

11. A modular emergency preparedness system comprising:
at least one server;
at least one processor communicatively coupled with the at least one server, the at least one processor configured to determine that an emergency has occurred and identify a type and a location of the emergency;
an application executing on at least one user device associated with a user, the application configured to determine a location of the user;
a communication unit communicatively coupled with the at least one server, the communication unit configured to send personalized instructions to the user device, over a communication network, based at least in part on one or more of the type of the emergency, the location of the user relative to the location of the emergency, a role of the user and a language preference of the user;
an off-network communication module within the application configured to receive encoded data embedded in radio signals that are distributed by a radio broadcast source in the event of a failure of the communication network, and further configured to decode the data for at least one of visual and audible presentation of the decoded data to the user on the at least one user device; and
an interactive broadcast platform communicatively coupled with the at least one server, the interactive broadcast platform configured to maintain up-to-date information pertaining to the emergency, based on real-time data, for display to the user on the at least one user device, the interactive broadcast platform further configured to receive user submitted data from a plurality of users and facilitate two-way communication between the plurality of users;
an artificial intelligence moderation engine communicatively coupled with the at least one server, the artificial intelligence moderation engine configured to filter the user submitted data for accuracy and relevance; and
a simulation engine communicatively coupled with the at least one server, the simulation engine configured to simulate a plurality of emergency events, track user decisions during simulation of each of the plurality of emergency events, generate a resilience score based at least in part on the user decisions and store user history and performance data on the at least one server.

12. The modular emergency preparedness system of claim 11, wherein the encoded data embedded in radio signals includes inaudible audio frequencies broadcast over standard radio waves.

13. The modular emergency preparedness system of claim 12, wherein the at least one user device includes a microphone, and wherein the application receives the inaudible audio frequencies via the microphone.

14. The modular emergency preparedness system of claim 12, wherein the at least one user device includes a smartphone, wherein at least a portion of the decoded data is presented as emergency instructions on at least one of a display and a speaker of the smartphone, and wherein the emergency instructions are personalized, based at least in part on one or more of the type of the emergency, the location of the user relative to the location of the emergency, the role of the user and the language preference of the user.

15. The modular emergency preparedness system of claim 11, wherein the at least one server is at least one of cloud-based, hybrid and local.

16. A method for emergency preparedness, the method comprising the steps of:
determining, by at least one processor communicatively coupled with at least one server, that an emergency has occurred;
identifying, by the at least one processor, a type of the emergency;
identifying, by the at least one processor, a location of the emergency;
determining, by an application executing on at least one user device associated with a user, a location of the user;
sending, by a communication unit communicatively coupled with the at least one server, personalized instructions to the at least one user device over a communication network, based at least in part on one or more of the type of the emergency, the location of the user relative to the location of the emergency, a role of the user and a language preference of the user; and
in the event of a failure of the communication network:
receiving, by an off-network communication module within the application, encoded data embedded in radio signals distributed by a radio broadcast source;
decoding, by the off-network communication module, the data; and
at least one of visually and audibly presenting, by the off-network communication module, the decoded data to the user on the at least one user device.

17. The method of claim 16, further comprising the steps of maintaining, by an interactive broadcast platform communicatively coupled with the at least one server and accessible via the at least one user device, up-to-date information pertaining to the emergency, based on real-time data; and
upon request by the at least one user device, displaying the up-to-date information pertaining to the emergency to the user on the at least one user device.

18. The method of claim 17, further comprising the steps of receiving, by the interactive broadcast platform, user submitted data from a plurality of users; and
saving the user submitted data on the at least one server for display on the at least one user device.

19. The method of claim 18, further comprising the step of filtering, by an artificial intelligence moderation engine communicatively coupled to the at least one server, the user submitted data for accuracy and relevance prior to the step of saving the user submitted data on the at least one server for display on the at least one user device.

20. The method of claim 19, further comprising the step of receiving, by a car stereo system, the encoded data embedded in radio signals distributed by the radio broadcast source, and wherein at least a portion of the decoded data is displayed as a QR code.
